(19) United States
(12) Patent Application Publication
(10) Pub. No.: US 2026/0002501 A1
(43) Pub. Date: Jan. 1, 2026

(54) INTAKE STRUCTURE AND VEHICLE

(71) Applicant: KAWASAKI MOTORS, LTD., Akashi-shi (JP)

(72) Inventor: Ayumi HAMADA, Akashi-shi (JP)

(21) Appl. No.: 18/758,651

(22) Filed: Jun. 28, 2024

(51) Int. Cl. F02M 35/10; F02M 35/02; F02M 35/16; F02M 61/14

(52) U.S. Cl. CPC F02M 35/10216; F02M 35/0201; F02M 35/10078; F02M 35/162; F02M 61/14

(57) ABSTRACT

An intake structure for an internal combustion engine of a vehicle includes: an intake passage structural body defining an intake passage which is connected to the internal combustion engine and through which intake air to be supplied to the internal combustion engine flows, the intake passage structural body including an intake port and a recess which is located between the intake port and the internal combustion engine and is recessed toward the intake passage; a first injector located between the recess and the internal combustion engine and connected to the intake passage structural body so as to inject fuel into the intake passage; and a second injector located inside the recess and connected to the intake passage structural body so as to inject the fuel into the intake passage.

### BACKGROUND ART

### Field of the Invention

The present disclosure relates to an intake structure and a vehicle.

### Description of the Related Art

Japanese Laid-Open Patent Application Publication No. 2017-186967 discloses a vehicle including a first injector connected to a throttle body and a second injector connected to an air cleaner. The first injector and the second injector inject fuel to an intake passage through which intake air to be supplied to an engine flows.

The position and shape of a space around the intake passage may vary depending on the structure of the vehicle. Therefore, it may be difficult to locate the first injector or the second injector at a desired position or in a desired direction.

### SUMMARY OF THE INVENTION

An object of one aspect of the present disclosure is to provide an intake structure for an internal combustion engine of a vehicle and a vehicle, each of which facilitates the positioning of an injector.

An intake structure for an internal combustion engine of a vehicle according to one aspect of the present disclosure includes: an intake passage structural body defining an intake passage which is connected to the internal combustion engine and through which intake air to be supplied to the internal combustion engine flows, the intake passage structural body including an intake port and a recess which is located between the intake port and the internal combustion engine and is recessed toward the intake passage; a first injector located between the recess and the internal combustion engine and connected to the intake passage structural body so as to inject fuel into the intake passage; and a second injector located inside the recess and connected to the intake passage structural body so as to inject the fuel into the intake passage.

### BRIEF DESCRIPTION OF THE DRAWINGS

The above object, other objects, features, and advantages of the present disclosure will be made clear by the following detailed description with reference to the attached drawings.

FIG. 1 is a side view showing one example of the configuration of a vehicle according to an exemplary embodiment.

FIG. 2 is an enlarged side view showing an intake structure of FIG. 1 and its vicinity.

FIG. 3 is an enlarged sectional view showing a second injector of FIG. 2 and its vicinity.

FIG. 4 is a perspective view showing a holder of FIG. 3 when viewed obliquely from above.

FIG. 5 is a perspective view showing one example of the configuration of fuel pipes of a first injector and the second injector according to the embodiment.

### DETAILED DESCRIPTION

Hereinafter, an exemplary embodiment of the present disclosure will be described with reference to the drawings. The embodiment described below is a comprehensive or specific example. Among components in the following embodiment, components that are not recited in independent claims which embody the broadest concept of the present disclosure will be described as optional components. The diagrams in the attached drawings are schematic diagrams and are not necessarily strictly drawn. In the diagrams, the same reference signs are used for the substantially identical components, and the repetition of the same explanation may be avoided, or such explanation may be simplified.

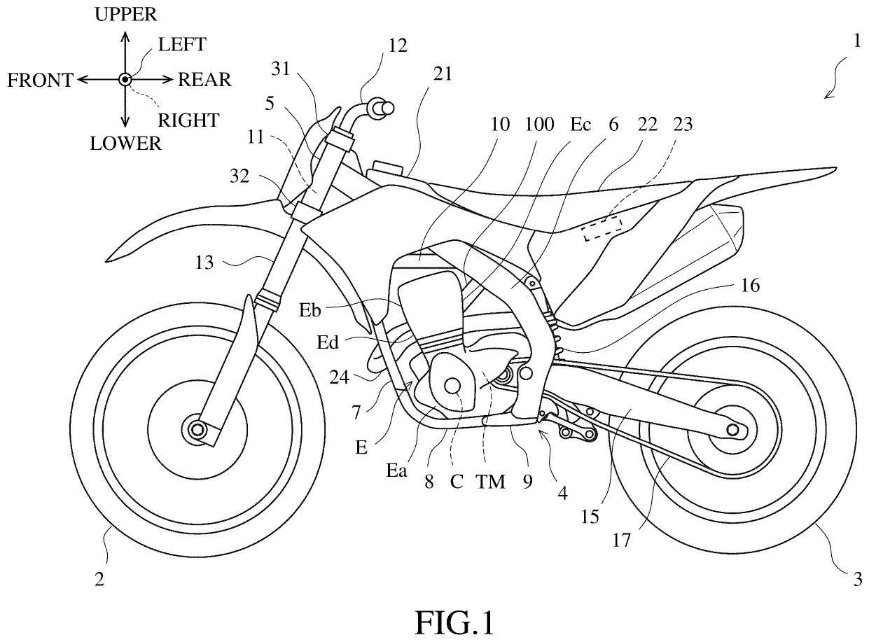

A vehicle 1 according to the exemplary embodiment will be described with reference to FIG. 1. FIG. 1 is a side view showing one example of the configuration of the vehicle 1 according to the exemplary embodiment. In the present embodiment, the vehicle 1 is a motorcycle but is not limited to this. Specifically, the motorcycle is a straddled vehicle of a motocross type which can travel on an irregular ground, i.e., the motorcycle is a straddled off-road traveling vehicle. In the following description, the “vehicle 1” may be referred to as a “motorcycle 1.”

The motorcycle 1 includes a front wheel 2, a rear wheel 3, and a vehicle body frame 4. As frame elements, the vehicle body frame 4 includes a head pipe 5, a pair of main frames 6 as left and right main frames, a down frame 7, a pair of lower frames 8 as left and right lower frames, a pivot frame 9, and bridge frames 10. In the vehicle body frame 4, the frame elements are joined to each other by welding.

Herein, in the present specification and the claims, an upper direction, upward, a lower direction, downward, a front direction, forward, a rear direction, rearward, a left direction, leftward, a right direction, rightward, a lateral direction, and lateral indicate directions based on the motorcycle 1 located on a horizontal surface. The upper direction and upward indicate a direction from the horizontal surface toward the motorcycle 1. The lower direction and downward indicate a direction from the motorcycle 1 toward the horizontal surface. The front direction and forward indicate an advancing direction of the motorcycle 1. The rear direction, rearward, the left direction, leftward, the right direction, rightward, the lateral direction, and lateral indicate directions with respect to the front direction or forward.

The head pipe 5 is a tubular body including an axis extending in an upper-lower direction. The main frames 6 extend downward and rearward from an upper portion of the head pipe 5. The down frame 7 is located at a forward position relative to the main frames 6 and extends downward and rearward from a lower portion of the head pipe 5. The lower frames 8 extend downward from a lower portion of the down frame 7, curve, and extend rearward. The pivot frame 9 couples rear portions of the main frames 6 and rear portions of the lower frames 8. The bridge frames 10 couple the main frames 6 and the down frame 7 so as to form gussets.

The motorcycle 1 further includes a steering shaft 11 that is in the head pipe 5 and rotatable. An upper bracket 31 and an under bracket 32 are respectively attached to upper and lower portions of the steering shaft 11. The motorcycle 1 further includes: a handlebar 12 attached to the upper bracket 31; and a pair of front forks 13 as left and right front forks including respective upper portions connected to the upper bracket 31 and the under bracket 32. Lower portions of the front forks 13 support the front wheel 2 such that the front wheel 2 is rotatable. A rider turns the handlebar 12 to steer the front wheel 2 through the steering shaft 11 and the front forks 13.

The motorcycle 1 further includes: a swing arm 15 extending in a front-rear direction; and a rear suspension 16 extending in the upper-lower direction. A front portion of the swing arm 15 is supported by the pivot frame 9 such that the swing arm 15 is pivotable. A rear portion of the swing arm 15 supports the rear wheel 3 as a driving wheel such that the rear wheel 3 is rotatable. The rear suspension 16 is connected to the swing arm 15 and the main frames 6.

The motorcycle 1 further includes an internal combustion engine E. The internal combustion engine E is located in a space surrounded by the main frames 6, the down frame 7, the lower frames 8, and the pivot frame 9. The internal combustion engine E is fixed to portions of the vehicle body frame 4.

The internal combustion engine E includes a crankcase Ea and a cylinder block Eb extending upward from an upper portion of the crankcase Ea. In the present embodiment, the cylinder block Eb is a cylinder block for a single cylinder, and one piston is accommodated in one cylinder bore so as to be slidable. However, the present embodiment is not limited to this. The cylinder block Eb includes: an intake port Ec located at a rear portion of the cylinder block Eb; and an exhaust port Ed located at a front portion of the cylinder block Eb.

The crankcase Ea accommodates: a crankshaft C connected to the piston through a connecting rod; and a transmission TM connected to the crankshaft C. The transmission TM is located rearward of the crankshaft C and transmits driving power of the crankshaft C to the rear wheel 3 through a power transmitting member 17, such as a chain or a belt.

The motorcycle 1 further includes a fuel tank 21 in a space between the pair of main frames 6. The fuel tank 21 is supported by the main frames 6. The motorcycle 1 further includes a seat 22 which is located rearward of the fuel tank 21 and straddled by the rider. The motorcycle 1 further includes an electronic control unit 23 which is located under the seat 22 and controls various components of the motorcycle 1. The electronic control unit 23 is also called an ECU.

The motorcycle 1 further includes an exhaust pipe 24 connected to the exhaust port Ed of the cylinder block Eb. The exhaust pipe 24 defines an exhaust passage through which exhaust gas discharged from the exhaust port Ed is discharged to outside air.

The motorcycle 1 further includes an intake structure 100 connected to the intake port Ec of the cylinder block Eb. The intake structure 100 is a structure that introduces air into the cylinder block Eb through the intake port Ec. In the present embodiment, the intake structure 100 introduces a fuel-air mixture including air and fuel for the internal combustion engine E into the cylinder block Eb.

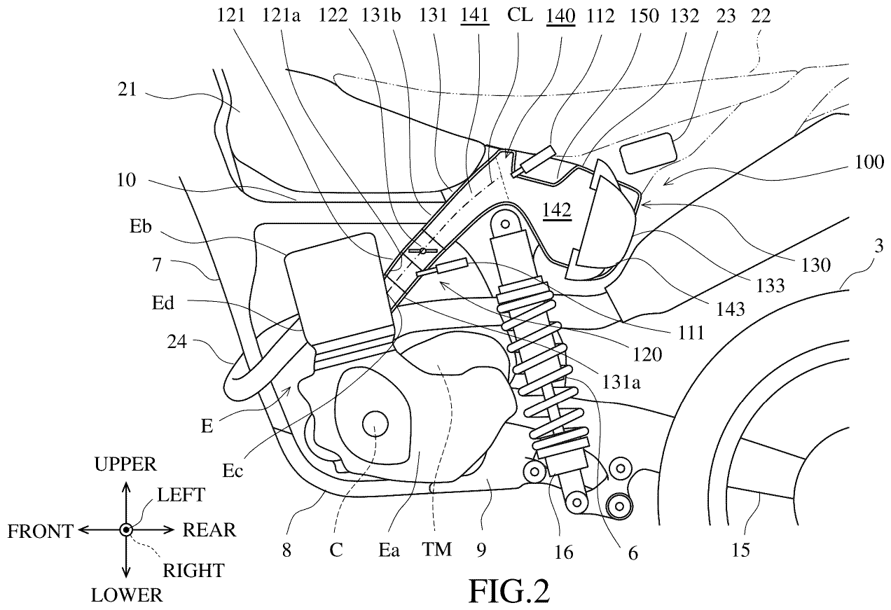

FIG. 2 is an enlarged side view showing the intake structure 100 of FIG. 1 and its vicinity. In FIG. 2, throttle equipment 120 and an intake passage structural body 130 are shown as sectional views. Moreover, the components of the motorcycle 1 which are located to the left of the internal combustion engine E are not shown.

As shown in FIG. 2, the intake structure 100 includes a first injector 111, a second injector 112, the throttle equipment 120, and the intake passage structural body 130.

The intake passage structural body 130 defines an intake passage 140. The intake passage 140 is connected to the intake port Ec of the cylinder block Eb. Intake air to be supplied to the internal combustion engine E flows inside the intake passage 140. The intake passage 140 is located between the pair of main frames 6 and extends upward and rearward from the intake port Ec.

In the present embodiment, the intake passage 140 includes: a channel portion 141 including a proximal end with respect to the internal combustion engine E, the proximal end communicating with the intake port Ec; and a chamber portion 142 connected to a distal end of the channel portion 141. However, the present embodiment is not limited to this. The channel portion 141 is a tubular channel and extends, from the intake port Ec, upward and rearward, i.e., obliquely upward. The channel portion 141 has such a tapered shape that a channel cross-sectional area of the channel portion 141 increases from the proximal end toward the distal end.

The chamber portion 142 extends rearward from the distal end of the channel portion 141 and includes an intake port 143 that is open rearward. The chamber portion 142 has a cross-sectional area larger than the channel cross-sectional area of the channel portion 141 and has such a shape that the cross-sectional area of the chamber portion 142 increases from the channel portion 141 toward the intake port 143. The intake port 143 is located at an upstream end of the intake passage 140 and takes air, which is outside air, into the intake passage 140.

The intake passage structural body 130 includes: a first structural body 131 defining the channel portion 141; a second structural body 132 defining the chamber portion 142; and an air cleaner 133 located inside the chamber portion 142. The first structural body 131 has a tubular shape. The first structural body 131 includes: a downstream end connected to the intake port Ec; and an upstream end connected to the second structural body 132.

In the present specification and the claims, the terms “upstream” and “downstream” denote “upstream” and “downstream” in a direction from the intake port 143 toward the intake port Ec in the intake passage 140, i.e., a direction in which the air flows in the intake passage 140.

The first structural body 131 has such a tapered shape that a cross-sectional area of the first structural body 131 decreases toward the intake port Ec from a connection portion which is shown by a broken line and connected to the second structural body 132. The second structural body 132 has such a shape that a cross-sectional area of the second structural body 132 is larger than that of the first structural body 131. The second structural body 132 defines the intake port 143 and has such a shape that the cross-sectional area of the second structural body 132 decreases from the intake port 143 toward the first structural body 131. The cross-sectional area is a cross-sectional area intersecting a direction from the upstream to the downstream.

In the present embodiment, both of the first structural body 131 and the second structural body 132 include resin as a constituent material. However, the present embodiment is not limited to this. Each of below-described two members 131a and 131b of the first structural body 131 is an integrally molded product made of resin. The second structural body 132 is an integrally molded product made of resin.

The air cleaner 133 is located adjacent to the intake port 143 and collects solid matters, such as particles and dusts, contained in outside air introduced through the intake port 143.

The intake passage structural body 130 includes a recess 150 which is located between the intake port 143 and the intake port Ec and at the first structural body 131, the second structural body 132, or the connection portion between the first structural body 131 and the second structural body 132. The recess 150 is recessed toward the intake passage 140 from a wall of the first structural body 131, the second structural body 132, or the connection portion.

In the present embodiment, the recess 150 is located at the second structural body 132. The recess 150 is located at an upper portion of the second structural body 132 and close to the connection portion between the first structural body 131 and the second structural body 132. The recess 150 is recessed downwardly from the wall of the second structural body 132 toward the chamber portion 142. The intake passage 140 changes its extending direction at the position of the recess 150. To be specific, the recess 150 is located at a portion where the extending direction of the intake passage 140 changes. In the present embodiment, the connection portion between the first structural body 131 and the second structural body 132 is located below the fuel tank 21 or the seat 22.

The recess 150 may be located below the fuel tank 21 or the seat 22. In the present embodiment, the second structural body 132 is located under the seat 22 together with the electronic control unit 23, and therefore, the recess 150 is also located under the seat 22. The recess 150 is located in a space under the seat 22. In the present embodiment, the recess 150 is located on a passage center line of a portion, located between the first injector 111 and the recess 150, of the intake passage 140. However, the present embodiment is not limited to this. Specifically, the recess 150 is located on an upward extended line of a channel center line CL of the channel portion 141. The second injector 112 is located inside the recess 150.

In the present specification and the claims, the expression “located on the passage center line” may denote “located on the passage center line itself” or “located on an extended line of the passage center line.” The extended line of the passage center line may denote a line obtained by extending the passage center line while maintaining the curvature of the passage center line or a line obtained by extending a tangential line of the passage center line.

Since the motorcycle 1 according to the present embodiment is of a motocross type, the motorcycle 1 requires a large road clearance below the lower frames 8. Therefore, the components, such as the internal combustion engine E and its accessories, of the motorcycle 1 which are located inside the vehicle body frame 4 are tightly located upward, i.e., toward the fuel tank 21 and the seat 22. Moreover, the electronic control unit 23 is located below a rear portion of the seat 22. Then, the recess 150 is recessed downwardly at the upper portion of the second structural body 132, and the second injector 112 is located inside the recess 150. The recess 150 and the second injector 112 can be located by utilizing a small gap between the second structural body 132 and the fuel tank 21 or between the second structural body 132 and the seat 22.

The throttle equipment 120 includes a throttle body 121 and a throttle valve 122. The throttle body 121 is located at the intake passage 140 and between the recess 150 and the internal combustion engine E. In the present embodiment, the throttle body 121 is located so as to be interposed at a portion of the first structural body 131. Therefore, the first structural body 131 includes two members 131a and 131b sandwiching the throttle body 121. The throttle body 121 includes therein a cylindrical through hole 121a, and the through hole 121a defines the channel portion 141 together with the first structural body 131.

The throttle valve 122 is located inside the through hole 121a of the throttle body 121 so as to be able to operate. The throttle valve 122 operates to control the amount of air supplied to the internal combustion engine E. The throttle valve 122 has a plate shape whose outer shape is the same as the sectional shape of the through hole 121a. The throttle valve 122 rotates about a shaft. The throttle valve 122 rotates between a closed position at which the throttle valve 122 completely closes the through hole 121a and an open position at which the throttle valve 122 completely opens the through hole 121a.

The first injector 111 is located between the recess 150 and the internal combustion engine E and is connected to the intake passage structural body 130 so as to inject the fuel into the intake passage 140. Specifically, the first injector 111 is connected to the intake passage structural body 130 through the throttle body 121 and is attached to the throttle body 121 at a position closer to the intake port Ec than the throttle valve 122. The first injector 111 is directed so as to inject the fuel in a mist form downstream from the first injector 111 and toward the channel center line CL of the channel portion 141. In FIG. 2, the first injector 111 is directed so as to inject the fuel forward and downward.

The second injector 112 is located inside the recess 150 and is directed so as to inject the fuel downstream from the second injector 112 and toward the passage center line of the intake passage 140.

In the present embodiment, the second injector 112 is directed so as to inject the fuel in a mist form along the channel center line CL of the channel portion 141. Moreover, since the recess 150 is located on the upward extended line of the channel center line CL, the second injector 112 is located on or in the vicinity of the extended line of the channel center line CL. The second injector 112 is directed such that a fuel injecting direction of the second injector 112 extends along the extended line. The fuel injecting direction of the second injector 112 may be a direction along the channel center line CL or a direction along the tangential line of the channel center line CL. Therefore, the second injector 112 can efficiently inject the fuel in a mist form toward the channel portion 141 while preventing the fuel from adhering to inner surfaces of the walls of the first and second structural bodies 131 and 132 and becoming drops.

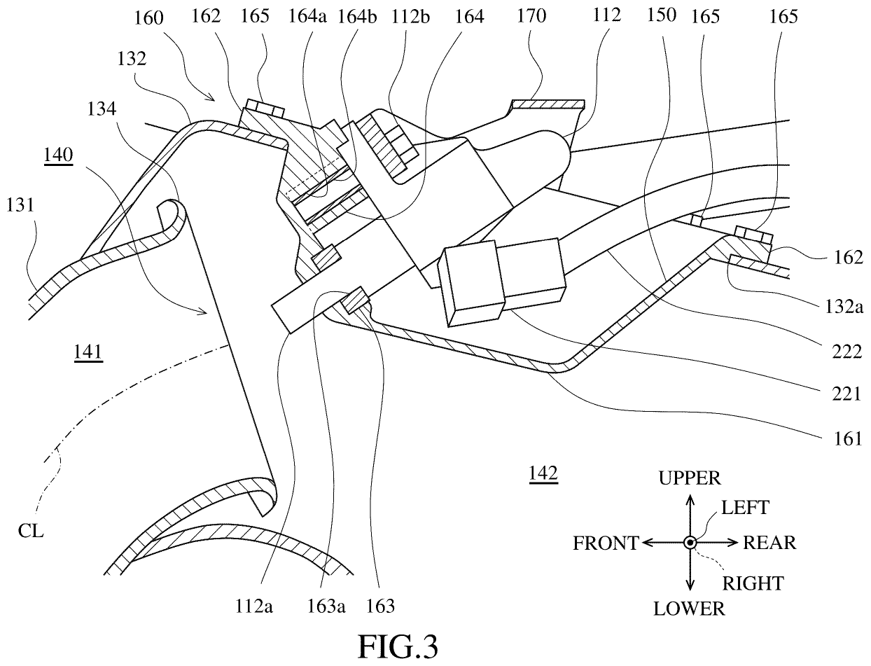

FIG. 3 is an enlarged sectional view showing the second injector 112 of FIG. 2 and its vicinity. In FIG. 3, the first structural body 131, the second structural body 132, a funnel 134, and a holder 160 are shown as sectional views. As shown in FIG. 3, the intake passage structural body 130 includes the funnel 134 located between the recess 150 and the first injector 111. The funnel 134 has such a tubular shape that the intake passage 140 widens from the first injector 111 toward the recess 150.

In the present embodiment, the funnel 134 is located at an upstream end of the first structural body 131 and is integrated with the first structural body 131. However, the present embodiment is not limited to this. The funnel 134 and the first structural body 131 define the channel portion 141. The funnel 134 extends inside the chamber portion 142 and projects inward beyond a wall of the chamber portion 142. The funnel 134 has such a funnel shape that the channel portion 141 widens from the downstream to the upstream. A cross section of an inner surface of the funnel 134 extending from the downstream to the upstream may be curved such that the channel portion 141 widens from the downstream to the upstream. The cross section of the inner surface of the funnel 134 extending from the downstream to the upstream may be curved such that the curvature of the cross section increases from the downstream to the upstream. The funnel 134 draws the air around the funnel 134 into the channel portion 141 to achieve an effect of increasing the flow velocity of the air flowing into the channel portion 141.

In the present embodiment, the second injector 112 and the recess 150 are located upstream from the funnel 134, and the second injector 112 is directed so as to inject the fuel toward an inside of a tube of the funnel 134.

Moreover, the intake passage structural body 130 includes the holder 160 which defines the recess 150 and is a member different from the first structural body 131 and the second structural body 132. The second structural body 132 includes, at the position of the recess 150, an opening 132a through which the chamber portion 142 communicates with an outside.

The holder 160 closes the opening 132a. The holder 160 has a structure for being attached to the second structural body 132 so as to close the opening 132a from an outside. The holder 160 has a structure for holding the second injector 112 at the inside of the recess 150.

The holder 160 includes: a recess wall 161 defining the recess 150; a flange 162 extending outward from a peripheral edge of the recess wall 161; a mounting base 163 located at the recess wall 161; and a fixed base 164 located at the recess wall 161. In the present embodiment, the holder 160 integrally includes the recess wall 161, the flange 162, and the fixed base 164. However, the present embodiment is not limited to this. As with the second structural body 132, the holder 160 includes resin as a constituent material. In the present embodiment, the holder 160 is an integrally molded product made of resin.

The flange 162 extends so as to surround a periphery of the recess 150 and is fixed to the second structural body 132 at a periphery of the opening 132a. In the present embodiment, the flange 162 is hermetically fixed to the second structural body 132 by using both of welding and screwing. However, the present embodiment is not limited to this. The flange 162 may be fixed to the second structural body 132 by one of welding or screwing or by another method, such as adhesion.

The mounting base 163 is located inside the recess 150 and fixed to the recess wall 161. In the present embodiment, the mounting base 163 is a member different from the recess wall 161 and is embedded in the recess wall 161. The mounting base 163 may be part of the recess wall 161. The mounting base 163 as the different member includes metal as a constituent material. The mounting base 163 may be molded integrally with the recess wall 161, the flange 162, and the fixed base 164 by a resin molding method, such as injection molding.

The mounting base 163 includes a through hole 163a through which a nozzle 112a of the second injector 112 extends. The mounting base 163 is directed so as to hold in a predetermined direction the second injector 112 including the nozzle 112a which has been inserted into the through hole 163a.

In the present embodiment, the position and direction of the second injector 112 held by the mounting base 163 are such a position and direction that with the flange 162 fixed to the second structural body 132, the second injector 112 does not project upward, i.e., toward an outside of the recess 150 beyond the flange 162. However, the present embodiment is not limited to this. The position and direction of the second injector 112 held by the mounting base 163 are such a position and direction that with the flange 162 fixed to the second structural body 132, the second injector 112 is directed so as to inject the fuel along the channel center line CL of the channel portion 141. The position and direction of the second injector 112 held by the mounting base 163 are such a position and direction that with the flange 162 fixed to the second structural body 132, the second injector 112 is directed so as to inject the fuel from the upstream of the funnel 134 to the inside of the funnel 134.

The fixed base 164 receives and is engaged with a screw 112b that fixes the second injector 112 to the holder 160. The fixed base 164 includes: a hole 164a that receives the screw 112b; and a collar 164b located inside the hole 164a. The collar 164b has a cylindrical shape, and an inner peripheral surface of the collar 164b includes an internal screw that is engaged with an external screw of the screw 112b. In the present embodiment, the fixed base 164 includes resin as a constituent material and is molded integrally with the recess wall 161 and the like. However, the present embodiment is not limited to this. The collar 164b may include metal as a constituent material and may be molded integrally with a resin member of the fixed base 164 by a resin molding method, such as injection molding.

Therefore, the nozzle 112a of the second injector 112 and a periphery of the nozzle 112a are positioned and held by the mounting base 163, and the second injector 112 is fixed to the fixed base 164 by the screw 112b.

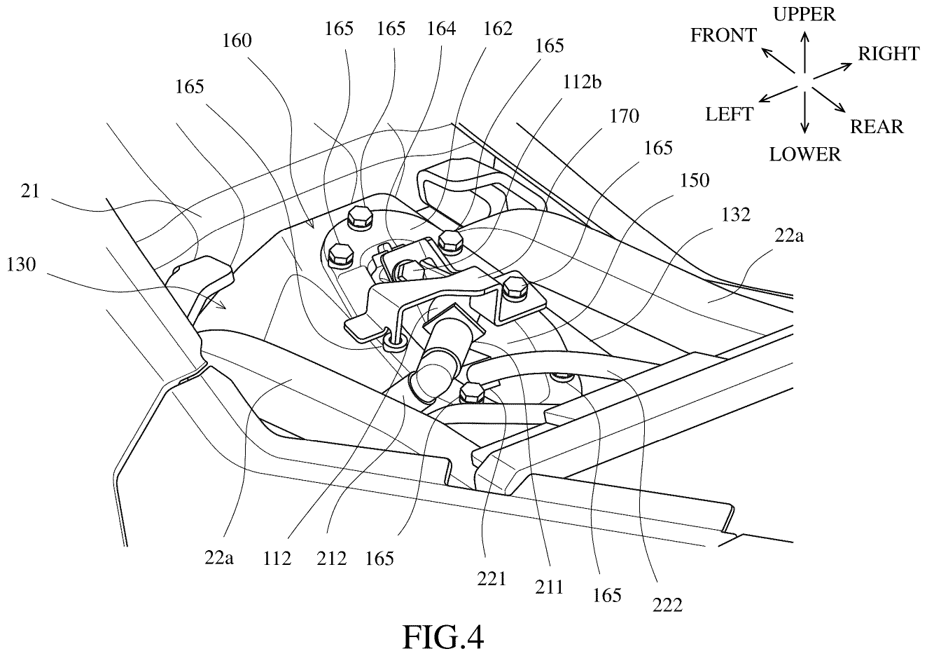

FIG. 4 is a perspective view showing the holder 160 of FIG. 3 when viewed obliquely from above. As shown in FIG. 4, the flange 162 of the holder 160 is fixed to the second structural body 132 with screws 165. The holder 160 is located rearward of the fuel tank 21 and between a pair of seat rails 22a supporting the seat 22. The seat rails 22a extend in the front-rear direction. The holder 160 is configured such that the holder 160 itself and the second injector 112 do not project upward beyond the fuel tank 21 and the seat rails 22a.

The intake passage structural body 130 further includes a protector 170 that covers the second injector 112 from above. In the present embodiment, the protector 170 extends in a left-right direction and covers the second injector 112 from above. However, the present embodiment is not limited to this. The protector 170 is fastened and fixed to the second structural body 132 together with the flange 162 with the screws 165. Moreover, the protector 170 is fastened and fixed to the fixed base 164 of the holder 160 together with the second injector 112 with the screw 112b. The protector 170 may include metal as a constituent material. In the present embodiment, the protector 170 includes a metal plate as a constituent material.

The second injector 112 is connected to a fuel pipe 212 through a fitting 211 and is connected to an electric cable 222 through a connector 221. In the present embodiment, the protector 170 covers at least a connection portion between the second injector 112 and the fitting 211 from above. The connection portion does not project upward beyond the protector 170. The protector 170 covers the connection portion from above, from the left, and from the right and protects the connection portion from collision from above, from the left, and from the right.

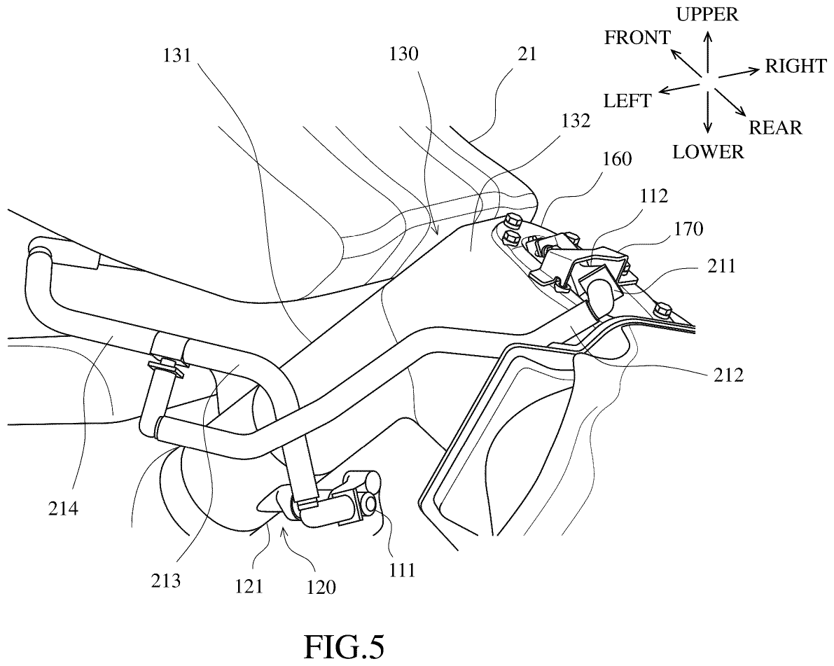

As shown in FIG. 5, the fuel pipe 212 extends downward and forward, joins a fuel pipe 213 extending from the first injector 111, and is connected to a fuel pipe 214. The fuel pipe 214 extends forward and is connected to the fuel tank 21. The first injector 111 and the second injector 112 may be simultaneously supplied with the fuel from a fuel pump in the fuel tank 21. FIG. 5 is a perspective view showing one example of the configuration of the fuel pipes of the first and second injectors 111 and 112 according to the embodiment.

Moreover, as shown in FIG. 2, since the first injector 111 located close to the intake port Ec can quickly supply the fuel to the cylinder block Eb, quick response of the internal combustion engine E is realized. Since the second injector 112 is located away from the intake port Ec, a period of time in which the fuel injected from the second injector 112 is mixed with the air is long. Therefore, the fuel-air mixture including the fuel and the air is cooled and condensed and is then supplied to the cylinder block Eb. Thus, the output of the internal combustion engine E can be improved.

Moreover, since the holder 160 is a member different from the first structural body 131 and the second structural body 132, each of the holder 160, the first structural body 131, and the second structural body 132 can be made by integral molding using resin. For example, when the first structural body 131 or the second structural body 132 integrally includes the holder 160, a mold for resin molding arranged inside the channel portion 141 or the chamber portion 142 interferes with the recess wall 161 and therefore cannot be removed. Thus, the integral molding is actually impossible. Therefore, the first structural body 131 including the holder 160 or the second structural body 132 including the holder 160 requires a dividable structure.

Moreover, a target position and target direction of the second injector 112 may vary depending on the structure of the motorcycle 1. Even in this case, the opening 132a may be located at the first structural body 131 or the second structural body 132 in accordance with the target position of the second injector 112. Moreover, the second injector 112 can located at the target position in the target direction by determining the structure of the holder 160 in accordance with the position of the opening 132a. Therefore, without largely changing the structures of the first and second structural bodies 131 and 132, the second injector 112 can be located at the target position in the target direction by changing the structure of the holder 160.

The foregoing has described the exemplary embodiment of the present disclosure. However, the present disclosure is not limited to the above embodiment. To be specific, various modifications and improvements may be made within the scope of the present disclosure. For example, embodiments prepared by variously modifying the embodiment and embodiments prepared by combining components in different embodiments are also included in the scope of the present disclosure.

For example, in the embodiment, the recess 150 is located at the second structural body 132. However, the present disclosure is not limited to this. The position of the recess 150 may be any position as long as the position is located at the intake passage 140 and upstream from the first injector 111. Moreover, the recess 150 is located at the upper portion of the second structural body 132, i.e., at the upper portion of the intake passage 140. However, the present disclosure is not limited to this. The position of the recess 150 at the intake passage 140 may be the upper portion, the lower portion, the front portion, the rear portion, the left portion, the right portion, or any other position.

In the embodiment, the recess 150 and the second injector 112 are located upstream of the funnel 134 and in the vicinity of the funnel 134. However, the present disclosure is not limited to this. For example, the positions of the recess 150 and the second injector 112 may be downstream of the funnel 134.

In the embodiment, the recess 150 is recessed downward. However, the present disclosure is not limited to this. A direction in which the recess 150 is recessed may be a direction from the opening to which the holder 160 is attached, toward the intake passage 140 located at the inside of the opening.

In the embodiment, the intake passage 140 is defined by two members that are the first structural body 131 and the second structural body 132. However, the intake passage 140 may be defined by a single member or may be defined by three or more members. In the latter case, the holder 160 and the recess 150 may be located at one or more of the three or more members.

In the embodiment, the intake structure 100 is used for the internal combustion engine E of a single cylinder. However, the intake structure 100 may be used for the internal combustion engine of multiple cylinders. In this case, the second injectors 112 may be located at respective intake passages extending from the multiple cylinders, or the second injector 112 may be located at a single intake passage into which the intake passages extending from the multiple cylinders are collected. The holder 160 and the recess 150 may be located at each of the positions of the second injectors 112.

In the embodiment, in the intake passage 140, the chamber portion 142 extends rearward from the channel portion 141. However, the present disclosure is not limited to this. For example, the chamber portion 142 may extend forward from the channel portion 141.

In the embodiment, the motorcycle 1 is a straddled vehicle including step bars at the lateral sides with respect to the seat. However, the motorcycle 1 may be a scooter vehicle including a floorboard in front of the seat.

In the embodiment, the motorcycle is described as the vehicle 1 including the intake structure 100. However, the present disclosure is not limited to this. The vehicle 1 may be any vehicle as long as the vehicle includes the internal combustion engine. For example, the vehicle 1 may have a structure for moving with one or more persons on the vehicle 1. The vehicle 1 may be controlled by a person on the vehicle 1 or may be remotely controlled from an outside of the vehicle 1. Examples of the vehicle 1 may include motorcycles, automobiles, mopeds, water vehicles, and other various mobilities. Examples of the automobiles may include passenger vehicles, freight vehicles, buses, all-terrain vehicles, and utility vehicles. Examples of the water vehicles may include freight ships, passenger ships, work ships, fishing boats, pleasure boats, and personal watercrafts.

Examples of aspects of the technology of the present disclosure will be described as below. An intake structure for an internal combustion engine of a vehicle according to a first aspect of the present disclosure includes: an intake passage structural body defining an intake passage which is connected to the internal combustion engine and through which intake air to be supplied to the internal combustion engine flows, the intake passage structural body including an intake port and a recess which is located between the intake port and the internal combustion engine and is recessed toward the intake passage; a first injector located between the recess and the internal combustion engine and connected to the intake passage structural body so as to inject fuel into the intake passage; and a second injector located inside the recess and connected to the intake passage structural body so as to inject the fuel into the intake passage.

According to the first aspect, since at least a part of the second injector is located inside the recess, the amount of projection of the second injector toward an outside of the intake passage structural body can be suppressed. Therefore, even when a space around the intake structural body is small, the second injector can be located in a desired direction by setting the shape and size of the recess accordingly. Moreover, the second injector can be located at a desired position by setting the position of the recess in accordance with a state around the intake passage structural body. Therefore, the second injector can be located at a desired position in a desired direction only by setting the position, shape, and size of the recess.

The intake structure according to a second aspect of the present disclosure may be configured such that in the first aspect, the intake passage structural body includes a mounting base which is located inside the recess and holds the second injector in a predetermined direction toward the intake passage, and the direction in which the mounting base holds the second injector is such a direction that a fuel injecting direction of the second injector extends along a passage center line of the intake passage.

According to the second aspect, the fuel in a mist form which is injected from the second injector is prevented from colliding with a wall of the intake passage and becoming drops. Therefore, the fuel and the air can be efficiently mixed with each other.

The intake structure according to a third aspect of the present disclosure may be configured such that in the first or second aspect, the recess is located on a passage center line of a portion, located between the recess and the first injector, of the intake passage.

According to the third aspect, the direction of the second injector is easily set such that the fuel in a mist form which is injected from the second injector does not collide with the wall of the intake passage.

The intake structure according to a fourth aspect of the present disclosure may be configured such that in any one of the first to third aspects, the recess is located under a fuel tank or a seat included in the vehicle that is a straddled vehicle.

According to the fourth aspect, a space under the fuel tank or the seat can be effectively utilized.

The intake structure according to a fifth aspect of the present disclosure may be configured such that in any one of the first to fourth aspects, the intake passage structural body includes a mounting base which is located inside the recess and holds the second injector in a predetermined direction toward the intake passage and a tubular funnel which is located between the recess and the first injector and by which the intake passage widens from the first injector toward the recess, and the direction in which the mounting base holds the second injector is such a direction that a fuel injecting direction of the second injector is directed to an inside of the funnel.

According to the fifth aspect, the flow velocity of the air is increased by the funnel. Since the fuel is injected from the second injector toward the flow of the air whose flow velocity has been increased, the fuel may be uniformly mixed with the air while maintaining a mist state. Therefore, the fuel-air mixture can be suitably supplied to the internal combustion engine.

The intake structure according to a sixth aspect of the present disclosure may be configured such that in any one of the first to fifth aspects, the intake structure further includes a throttle body located at the intake passage and between the recess and the internal combustion engine, and the first injector is connected to the throttle body.

According to the sixth aspect, the flow rate of the fuel-air mixture including the air and the fuel is adjusted by the throttle body. The first injector can inject the fuel to the fuel-air mixture whose flow rate has been adjusted. Therefore, the suitable fuel-air mixture containing a desired amount of fuel can be supplied to the internal combustion engine.

The intake structure according to a seventh aspect of the present disclosure may be configured such that in any one of the first to sixth aspects, the second injector is connected to a fuel pipe through a fitting, and the intake passage structural body includes a protector covering a connection portion between the second injector and the fitting from above.

According to the seventh aspect, since the protector protects the connection portion, the connection between the second injector and the fitting can be surely held.

The intake structure according to an eighth aspect of the present disclosure may be configured such that in any one of the first to seventh aspects, the intake passage includes a channel portion including a proximal end communicating with the internal combustion engine and a chamber portion which is connected to a distal end of the channel portion and is open, the intake passage structural body includes a first structural body defining the channel portion, a second structural body defining the chamber portion, and an air cleaner located at an opening of the chamber portion, and the recess is located at a connection portion between the first structural body and the second structural body or at the second structural body.

According to the eighth aspect, the second injector may be located at a position relatively close to the air cleaner. Therefore, a distance between the first injector and the second injector can be set long. Thus, the fuel which has been injected from the second injector can be effectively mixed with the air before the fuel reaches the first injector.

The intake structure according to a ninth aspect of the present disclosure may be configured such that in any one of the first to eighth aspects, the intake passage includes a first portion extending from the internal combustion engine in an upper direction of the vehicle and a second portion extending from the first portion in a front or rear direction of the vehicle, the intake passage structural body includes a first structural body defining the first portion, a second structural body defining the second portion, and an air cleaner located at an opening of the second structural body, and the recess is located at a connection portion between the first structural body and the second structural body or at the second structural body.

According to the ninth aspect, when the recess is located at the connection portion, the second injector may be located at a portion where the extending direction of the intake passage changes. Therefore, the direction of the second injector is easily set such that the fuel in a mist form which is injected from the second injector does not collide with the wall of the intake passage. When the recess is located at the second structural body, a distance between the first injector and the second injector can be set long. Therefore, the fuel which has been injected from the second injector can be effectively mixed with the air before the fuel reaches the first injector.

The intake structure according to a tenth aspect of the present disclosure may be configured such that in any one of the first to ninth aspects, the intake passage structural body includes: an opening located between the intake port and the internal combustion engine; and a holder that closes the opening and holds the second injector, the holder including the recess that is recessed toward the intake passage beyond the opening and a mounting base that is located inside the recess and holds the second injector in a predetermined direction toward the intake passage.

According to the tenth aspect, even when a space around the intake structural body is small, the holder can hold the second injector in the predetermined direction. Moreover, the second injector can be located at a desired position in a desired direction in such a manner that: the position of the opening is set in accordance with a state around the intake passage structural body; the position and direction of the mounting base and the shape and size of the recess are set in accordance with the position of the opening; and the holder corresponding to the results of these settings is prepared. To be specific, the second injector can be located at a desired position in a desired direction only by setting the position of the opening and the configuration of the holder without largely transforming the intake passage structural body.

The intake structure according to an eleventh aspect of the present disclosure may be configured such that in the tenth aspect, the holder further includes a flange which extends around the recess and is fixed to the intake passage structural body at a periphery of the opening, and a position and direction of the second injector held by the mounting base are such a position and direction that the second injector does not project toward an outside of the recess beyond the flange.

According to the eleventh aspect, the holder can be strongly and hermetically fixed to the intake passage structural body by the fixing through the flange. Moreover, the amount of projection of the second injector from the intake passage structural body may be suppressed.

The intake structure according to a twelfth aspect of the present disclosure may be configured such that in the tenth or eleventh aspect, the holder further includes a flange which extends around the recess and is fixed to the intake passage structural body at a periphery of the opening, and the holder is an integrally molded product which includes resin and integrally includes the recess, the mounting base, and the flange.

According to the twelfth aspect, the holder can be strongly and hermetically fixed to the intake passage structural body by the fixing through the flange. Moreover, since the holder is the integrally molded product, the holder can hermetically close the opening.

A vehicle according to a thirteenth aspect of the present disclosure includes: wheels; an internal combustion engine that combusts a fuel-air mixture including air and fuel to output power; a driving structure that is connected to the internal combustion engine and transmits the power of the internal combustion engine to one or more of the wheels; an intake structure that supplies a fuel-air mixture including air and fuel to the internal combustion engine; a fuel tank located above the internal combustion engine; and a seat located rearward of the fuel tank, wherein the intake structure includes an intake passage structural body defining an intake passage which is connected to the internal combustion engine and through which intake air to be supplied to the internal combustion engine flows, the intake passage structural body including an intake port into which the air is taken and a recess which is located between the intake port and the internal combustion engine and is recessed toward the intake passage, a first injector located between the recess and the internal combustion engine and connected to the intake passage structural body so as to inject fuel into the intake passage, and a second injector located inside the recess and connected to the intake passage structural body so as to inject the fuel into the intake passage.

According to the thirteenth aspect, the vehicle having the same effects as the intake structure according to one aspect of the present disclosure can be obtained.

The vehicle according to a fourteenth aspect of the present disclosure may be configured such that in the thirteenth aspect, the vehicle is a straddled off-road traveling vehicle, the intake passage includes a first portion extending from the internal combustion engine in an upper direction of the vehicle and a second portion extending from the first portion in a front or rear direction of the vehicle, the intake passage structural body includes a first structural body defining the first portion, a second structural body defining the second portion, and an air cleaner located at an opening of the second structural body, the recess is located at a connection portion between the first structural body and the second structural body or at the second structural body, and the connection portion between the first structural body and the second structural body is located under the fuel tank or the seat.

According to the fourteenth aspect, in the straddled off-road traveling vehicle, to secure a large road clearance, the internal combustion engine and the intake structural body are located at relatively high positions. In such layout, the second injector is located while effectively utilizing a small space under the fuel tank or the seat. Moreover, the intake passage structural body may be configured such that the second injector can be located while suppressing the amount of projection, and therefore, the second injector can be located at a desired position in a desired direction.

All of the numerals used herein, such as the ordinal numbers and those indicating quantities, are examples used to specifically describe the technology of the present disclosure, and the present disclosure is not limited to those example numerals. Connection relationships among the components herein are mere examples to specifically describe the technology of the present disclosure, and connection relationships that realize the functions of the present disclosure are not limited to these examples.

As the present disclosure may be embodied in various forms without departing from the scope of the essential features thereof, the illustrative embodiment and variations are therefore illustrative and not restrictive, since the scope of the present disclosure is defined by the appended claims rather than by the description preceding them. All changes that fall within metes and bounds of the claims, or equivalence of such metes and bounds thereof are therefore intended to be embraced by the claims.

What is claimed is:

1. An intake structure for an internal combustion engine of a vehicle,
the intake structure comprising:
an intake passage structural body defining an intake passage which is connected to the internal combustion engine and through which intake air to be supplied to the internal combustion engine flows, the intake passage structural body including an intake port and a recess which is located between the intake port and the internal combustion engine and is recessed toward the intake passage;
a first injector located between the recess and the internal combustion engine and connected to the intake passage structural body so as to inject fuel into the intake passage; and
a second injector located inside the recess and connected to the intake passage structural body so as to inject the fuel into the intake passage.

2. The intake structure according to claim 1, wherein:
the intake passage structural body includes a mounting base which is located inside the recess and holds the second injector in a predetermined direction toward the intake passage; and
the direction in which the mounting base holds the second injector is such a direction that a fuel injecting direction of the second injector extends along a passage center line of the intake passage.

3. The intake structure according to claim 1, wherein the recess is located on a passage center line of a portion, located between the recess and the first injector, of the intake passage.

4. The intake structure according to claim 1, wherein the recess is located under a fuel tank or a seat included in the vehicle that is a straddled vehicle.

5. The intake structure according to claim 1, wherein:
the intake passage structural body includes
a mounting base which is located inside the recess and holds the second injector in a predetermined direction toward the intake passage and
a tubular funnel which is located between the recess and the first injector and by which the intake passage widens from the first injector toward the recess; and
the direction in which the mounting base holds the second injector is such a direction that a fuel injecting direction of the second injector is directed to an inside of the funnel.

6. The intake structure according to claim 1, further comprising a throttle body located at the intake passage and between the recess and the internal combustion engine, wherein
the first injector is connected to the throttle body.

7. The intake structure according to claim 1, wherein:
the second injector is connected to a fuel pipe through a fitting; and
the intake passage structural body includes a protector covering a connection portion between the second injector and the fitting from above.

8. The intake structure according to claim 1, wherein:
the intake passage includes
a channel portion including a proximal end communicating with the internal combustion engine and
a chamber portion which is connected to a distal end of the channel portion and is open;
the intake passage structural body includes
a first structural body defining the channel portion,
a second structural body defining the chamber portion, and
an air cleaner located at an opening of the chamber portion; and
the recess is located at a connection portion between the first structural body and the second structural body or at the second structural body.

9. The intake structure according to claim 1, wherein:
the intake passage includes
a first portion extending from the internal combustion engine in an upper direction of the vehicle and
a second portion extending from the first portion in a front or rear direction of the vehicle;
the intake passage structural body includes
a first structural body defining the first portion,
a second structural body defining the second portion, and
an air cleaner located at an opening of the second structural body; and
the recess is located at a connection portion between the first structural body and the second structural body or at the second structural body.

10. The intake structure according to claim 1, wherein the intake passage structural body includes:
an opening located between the intake port and the internal combustion engine; and
a holder that closes the opening and holds the second injector, the holder including
the recess that is recessed toward the intake passage beyond the opening and
a mounting base that is located inside the recess and holds the second injector in a predetermined direction toward the intake passage.

11. The intake structure according to claim 10, wherein:
the holder further includes a flange which extends around the recess and is fixed to the intake passage structural body at a periphery of the opening; and
a position and direction of the second injector held by the mounting base are such a position and direction that the second injector does not project toward an outside of the recess beyond the flange.

12. The intake structure according to claim 10, wherein:
the holder further includes a flange which extends around the recess and is fixed to the intake passage structural body at a periphery of the opening; and
the holder is an integrally molded product which includes resin and integrally includes the recess, the mounting base, and the flange.

13. A vehicle comprising:
wheels;
an internal combustion engine that combusts a fuel-air mixture including air and fuel to output power;
a driving structure that is connected to the internal combustion engine and transmits the power of the internal combustion engine to one or more of the wheels;
an intake structure that supplies a fuel-air mixture including air and fuel to the internal combustion engine;
a fuel tank located above the internal combustion engine; and
a seat located rearward of the fuel tank, wherein
the intake structure includes
an intake passage structural body defining an intake passage which is connected to the internal combustion engine and through which intake air to be supplied to the internal combustion engine flows, the intake passage structural body including an intake port into which the air is taken and a recess which is located between the intake port and the internal combustion engine and is recessed toward the intake passage,
a first injector located between the recess and the internal combustion engine and connected to the intake passage structural body so as to inject fuel into the intake passage, and
a second injector located inside the recess and connected to the intake passage structural body so as to inject the fuel into the intake passage.

14. The vehicle according to claim 13, wherein:
the vehicle is a straddled off-road traveling vehicle;
the intake passage includes
a first portion extending from the internal combustion engine in an upper direction of the vehicle and
a second portion extending from the first portion in a front or rear direction of the vehicle;
the intake passage structural body includes
a first structural body defining the first portion,
a second structural body defining the second portion, and
an air cleaner located at an opening of the second structural body;
the recess is located at a connection portion between the first structural body and the second structural body or at the second structural body; and
the connection portion between the first structural body and the second structural body is located under the fuel tank or the seat.
